(19) United States
(12) Patent Application Publication
(10) Pub. No.: US 2007/0181053 A1
(43) Pub. Date: Aug. 9, 2007

(54) Muffler sound simulator

(76) Inventor: Daniel W. Gray, Maple City, MI (US)

Correspondence Address: MCKELLAR IP LAW, PLLC, 784 SOUTH POSEYVILLE ROAD, MIDLAND, MI, 48640, US

(21) Appl. No.: 11/729,793

(22) Filed: Mar. 29, 2007

Related U.S. Application Data
(63) Continuation-in-part of application No. 11/325,594, filed on Jan. 4, 2006.

(51) Int. Cl. B60Q 5/00

(52) U.S. Cl. 116/59

(57) ABSTRACT

A muffler sound simulator for bicycles and other non-motorized vehicles or toys. The simulator is driven through the circular motion of the wheel. The bicycle wheel is engaged by a drive wheel that in turn manipulates a drive shaft that acts upon an actuator. The actuator rotates, striking the hammer. The duel action of the load spring and the repositioning spring allow the hammer to interface repeatedly against the tympanic membrane. The sound derived from the resonation of the membrane is directed through the hollow casing, amplifying the sound that is generated. Another embodiment of the device is a muffler sound simulator for bicycles and other non-motorized vehicles or toys that is a mechanically driven actuator that compresses a switch tab against a momentary contact switch that is electrically connected to a printed circuit, and a speaker for the reaction output of the printed circuit.

This application claims priority from U.S. Utility patent application Ser. No. 11/325,594 filed Jan. 4, 2006.

The present invention is a muffler sound simulator for bicycles and the like. The device has a drive mechanism that rotates an actuator. The actuator drives a hammer against a tympanic membrane. The device is held in position via a support arm that is connected to a bicycle frame at one end and a drive wheel that rests against a rear tire of the bike. The movement of the bike tire operates the drive, activating the sound simulation. The device is accompanied by a realistically shaped exhaust and mounted to a bicycle giving the sound and appearance of an actual muffler.

### BACKGROUND OF INVENTION

There are many forms of sound generating devices for non-motorized vehicles. In a first embodiment, the instant invention accomplishes sound generation by incorporating the drive capability derived from the circular motion of the rear wheel. The sound generation is the result of a hammer interacting with a tympanic head. The wheel motion drives an actuator that provides movement to the hammer striking the tympanic membrane and generating sound.

In a second embodiment, there is a device that is a muffler sound simulator for bicycles and other non-motorized vehicles or toys that is a mechanically driven actuator that compresses a switch tab against a momentary contact switch that is electrically connected to a printed circuit, and a speaker for the reaction output of the printed circuit.

The inventor herein is aware of two U.S. Patents that disclose motorcycle sound simulation for non-motorized vehicles. One such patent is U.S. Pat. No. 4,701,750 that issued on Oct. 20, 1987 to Wilkinson, et al in which there is disclosed a motorcycle sound simulator for non-motorized vehicles that is comprised of a sensor to detect motion of a wheel and then a signal is transmitted from the sensor to a control unit.

In another instance, U.S. Pat. No. 5,820,442 that issued on Oct. 13, 1998 to Heider discloses an electronic engine sound duplicator simulator used in combination with an internal combustion motor.

None of the prior art devices disclose or make obvious the devices of the instant invention.

### THE INVENTION

The present invention is a muffler sound simulator device. The device comprises a hollow housing and contained in the hollow housing is a muffler sound simulator comprising in combination a tympanic membrane that is affixed in the hollow housing. The hammer is positioned in striking alignment with the tympanic membrane. The hammer is mounted on a first axle wherein the first axle is mounted in the sides of the hollow housing and supported by the hollow housing. The hammer has a front, a back and a bottom. The hammer and axle are located so that the hammer is capable of periodically striking the tympanic membrane.

The hammer has a spring attachment located on each of the back and the front. The hammer has a notch in its back with the notch extending through the back and up to the first axle.

The actuator is mounted on a second axle. The second axle is mounted in the hollow housing and supported thereby. The second axle extends on one end, outside of the hollow housing.

Mounted on the second axle extended end is a rotatable drive wheel and a support frame. The support frame has a near end and a distal end and a centrally located cross member. The support frame is mountable to the frame of a bicycle at its distal end and the terminal end of the second axle is supported by the support frame at its near end.

One end of the tension spring is attached to the cross member and the opposite end of the spring is attached to the distal end of the support frame.

One end of a second spring is attached to the spring attachment on the back of the hammer and the opposite end is attached to the hollow housing.

One end of a third spring is attached to the spring attachment on the bottom of the hammer, the opposite end is attached to the hollow housing.

In another embodiment, there is a muffler sound simulator device wherein the device comprises a hollow housing and contained in said hollow housing, a muffler sound simulator comprising in combination a speaker, a printed circuit board with a predetermined circuit formed thereon, a battery array, a rotational actuator, and a momentary contact switch having at least three electrical connective tabs.

The printed circuit is electrically attached to the speaker, the battery array, and at one of the three electrical connective tabs of the momentary contact switch.

The battery array is electrically attached to one of the three electrical connective tabs that is not the same connection as the connection for the printed circuit and the speaker is electrically connected to one of the three electrical connective tabs that is not connected to either the printed circuit board or the battery array.

The rotational actuator is a cam that is mounted on an axle that is mounted in the housing. The rotational actuator is in periodic contact with a switch tab that is attached to the momentary contact switch. The switch tab is in constant contact with an actuator button mounted on the momentary contact switch such that when the cam rotates and presses the switch tab, the switch tab presses the actuator button and completes the circuit. When the cam is not pressing the switch tab, the switch tab does not press the actuator button and the circuit is not completed.

### BRIEF DESCRIPTION OF THE DRAWINGS

FIG. 1 is a full side view of the muffler sound simulator mounted to a bike with the drive wheel resting on the bicycle tire.

FIG. 2 is an internal view of the hollow casing featuring the tympanic head, hammer and actuator.

FIG. 3 is rear view of the tympanic membrane incorporated into the hollow casing.

FIG. 4 is a full view of the tympanic membrane incorporated into the tympanic membrane collar.

FIG. 5 is a full top view of the muffler sound simulator.

FIG. 5A is an enlarged view of the actuator and hammer.

FIG. 6 is a front view of the drive wheel.

FIG. 7 is a full side view of the adjustable bracket attached to the bike bracket.

FIG. 8 is a full side view of the support arm.

FIG. 9 is the hollow casing housing the tympanic membrane that is shown in phantom.

FIG. 10 is another embodiment of the invention showing a secondary actuator that is a wheel that is a flywheel.

FIG. 11 is a top view of the embodiment showing the secondary hammer tab.

FIG. 12 is a full side view of the muffler sound simulator mounted to a standard non-motorized vehicle wherein the vehicle is a bicycle and is shown in phantom.

FIG. 13 is a full side view of the second embodiment of this invention with one-half of the housing removed to show the contents therein.

FIG. 14 is a full side view of the second embodiment of this invention with one-half of the housing removed to show the contents therein and in addition, shows an off and on switch.

### DETAILED DESCRIPTION OF THE DRAWINGS

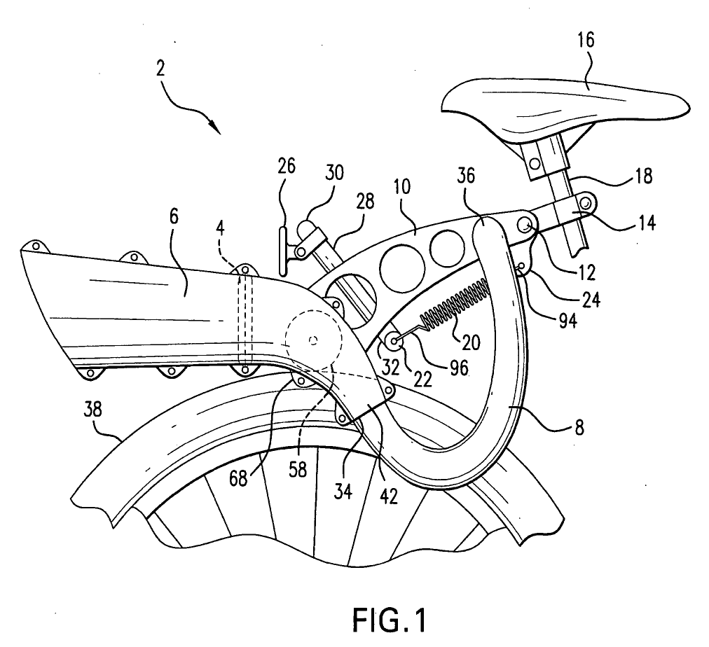

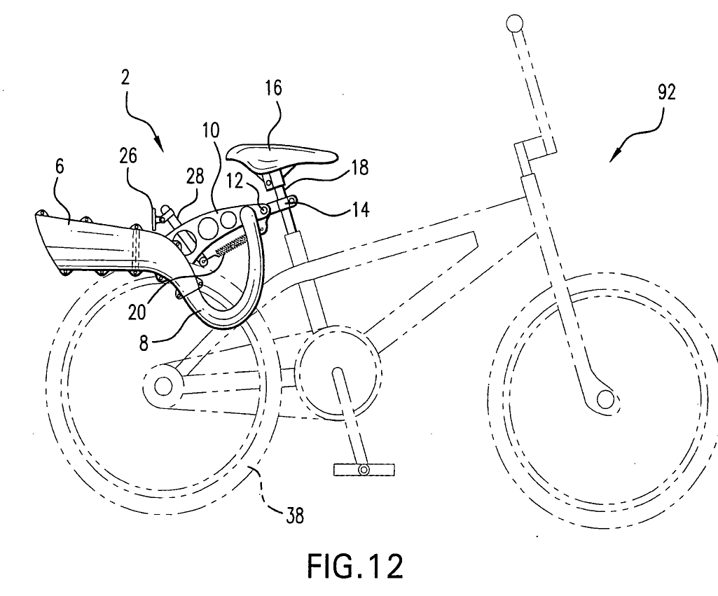

FIG. 1 is a full side view of the muffler sound simulator 2 mounted to a standard bicycle 92 with the drive wheel 58 resting on the bicycle tire 38. The muffler sound simulator 2 is attached to the seat post 18 via bicycle bracket 14 below the seat 16 of a standard bicycle 92 as shown in FIG. 12. The support arm 10 attaches to a bicycle bracket 14 at a pivot point 12. The near end 64 of support arm 10 contains the drive wheel 58 in phantom. The near end 24 of the bicycle bracket 14 retains the distal end 94 of tension spring 20. The purpose of the tension spring 20 is to keep the drive wheel 58 in constant contact with the bicycle tire 38. The near end 96 of tension spring 20 is attached to the near end attachment point 22 of the distal end 32 of mounting arm 28. The mounting arm 28 has a reflector 26 mounted approximately at it near end 30. The flexible hose 8 is attached to the support arm 10 at the distal end 36 of the flexible hose 8. The near end 34 of the flexible hose 8 attaches to the hollow casing 6 at its distal end 42. Also shown in phantom is the tympanic collar 54 holding the tympanic membrane 4 within the hollow casing 6.

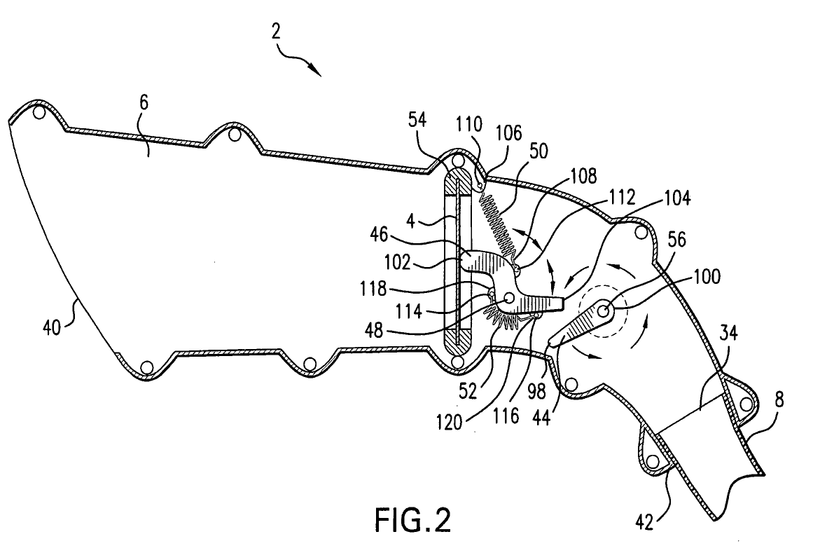

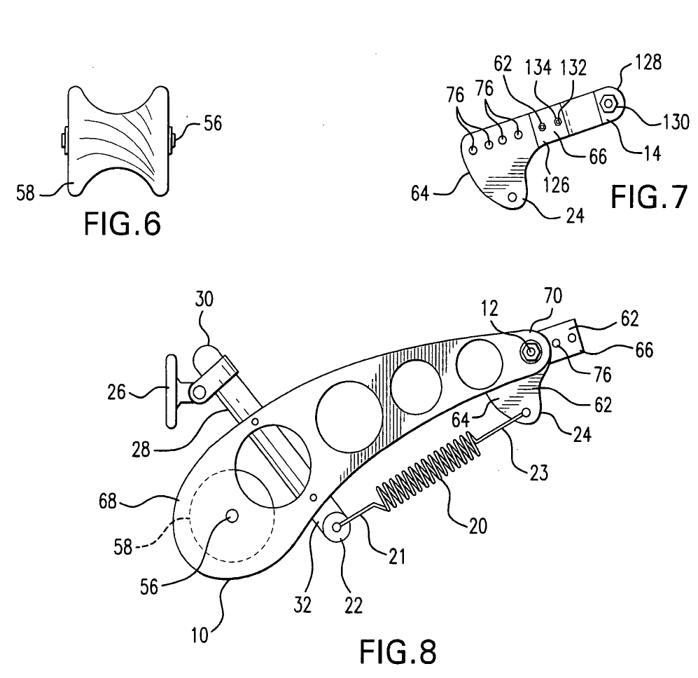

FIG. 2 is an internal view of the hollow casing 6 of the muffler sound simulator 2 including the tympanic membrane 4, the hammer 46 and actuator 44. The bicycle tire 38 rotates and acts upon the drive wheel 58 (FIG. 6). The drive wheel 58 (not shown) is attached to the drive shaft 56. The drive shaft 56 is attached to the distal end 100 of the actuator 44. This causes the actuator 44 to rotate, causing the near end 98 of the actuator 44 to act upon the distal end 104 of the hammer 46 by way of the pivot point 48 forcing the near end 102 of the hammer 46 to impact the tympanic membrane 4 incorporated in the tympanic membrane collar 54. This action is completed by a system of springs that reposition the hammer 46 through the reposition spring 50 and repositioning spring 52. The reposition spring 50 is attached at its near end 106 to the hollow casing 6 via the near end attachment point 110. The distal end 108 is attached to the hammer 46 at the distal end attachment 112. This repositioning spring 50 essentially composes the firing mechanism for the device. The repositioning spring 52 provides repositioning when the actuator 46 moves in a reverse direction returning the hammer 46 to its original position prior to reverse activation. The repositioning spring 52 near end 118 is attached to the hollow casing 6 at the near end attachment point 114 and the distal end 120 is attached to the hammer 46 at the distal end attachment point 116. The sound that is produced by the continuous striking of the hammer 46 against the tympanic membrane 4 is enhanced by traveling through the remainder to the hollow casing 6, similar to an echo chamber.

Also shown is the attachment of the hollow casing 6 at its distal end 42 and the flexible hose 8 at its near end 34.

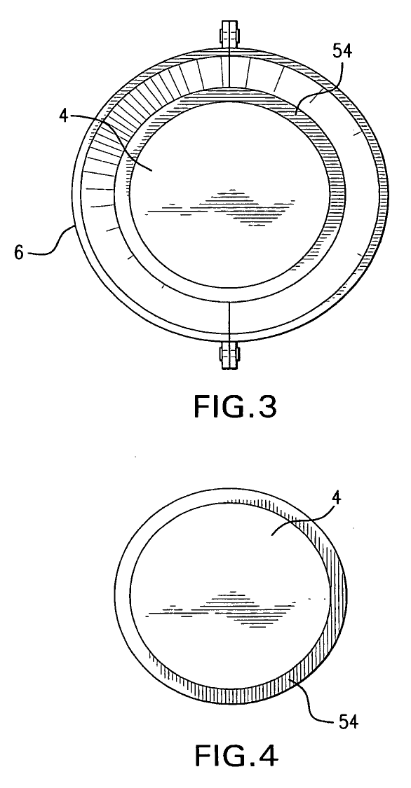

FIG. 3 is rear view of the tympanic membrane 4 incorporated into the hollow casing 6. This view is looking into the rear of the hollow casing 6 showing the tympanic membrane collar 54 with the tympanic membrane 4 being retained therein.

FIG. 4 is a full view of the tympanic membrane 4 incorporated into the tympanic membrane collar 54.

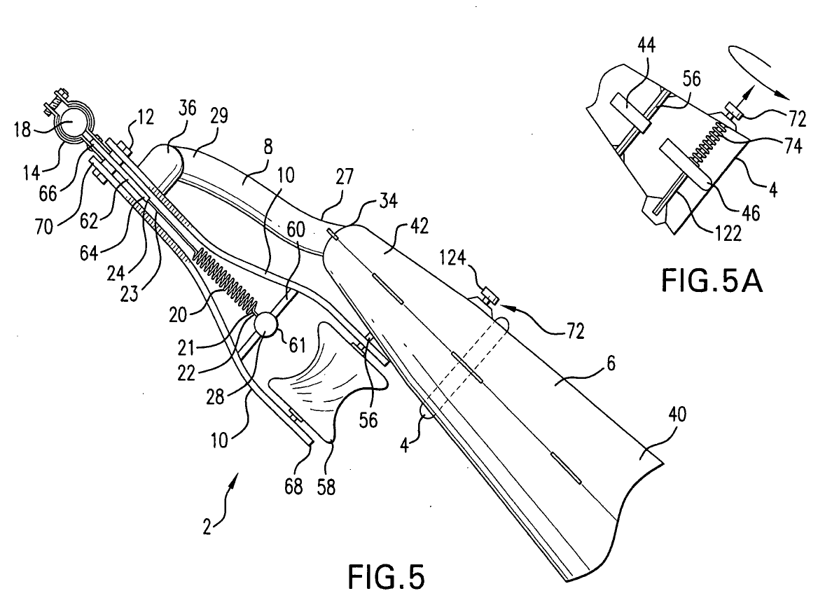

FIG. 5 is a full top view of the muffler sound simulator 2 with an enlarged view 5A of the actuator 44 and hammer 46. The muffler sound simulator 2 is attached to the bicycle seat post 18 via the bicycle seat bracket 14. Attached to the bicycle bracket 14 is the adjustable bracket 62. The adjustable bracket 62 has a near end 64 and a distal end 66. Not shown is the plurality of openings 72 through the adjustable bracket 62. The distal end 66 of adjustable bracket 62 contains the support 24 for the tension spring 20. The distal end 23 of the tension spring 20 is attached to the tension spring support 24. The near end 21 of tension spring 20 is attached to the near end tension spring support 22.

The distal end 70 of support arm 10 is attached to the adjustable bracket 62 at the pivot point 12. At essentially what is the support arm 10 midpoint is the support arm 10 cross member 60. Attached essentially at the midpoint 61 of the cross member 60 is the reflector/tension spring support post 28. Near the near end 68 of support arm 10 is the drive shaft 56 that holds the drive wheel 58. The drive shaft 56 penetrates one side of the hollow casing 6. The actuator 44 is secured to the drive shaft 56. The actuator 44 is driven by the drive wheel 58 and the actuator 44 acts upon the hammer 46 impacting the tympanic membrane 4 producing the muffler sound simulation that passes through the hollow casing 6 near end 40. In this embodiment the hammer 46 is mounted to the hammer shaft 122. The hammer shaft 122 is part of the disengagement mechanism 72. The disengagement mechanism 72 has a pull knob 124 that is pulled out and turned, successfully removing the hammer 46 from the path of the actuator 44. The hammer 46 shaft 122 is spring load via hammer shaft spring 74. When it is desired, the pull knob 124 can be pulled out and the sound is stopped.

Also present is the flexible hose 8. Its distal end 29 is attached to the distal end hose attachment point 36 and the near end 34 is attached at the near end 27 of hose attachment 34.

FIG. 6 is a front view of the drive wheel 58. This particular embodiment shows the drive wheel 58 grooved for better contact with the bicycle tire. The drive wheel 58 rotates upon the drive shaft 56.

FIG. 7 is a full side view of the adjustable bracket 62 attached to the bicycle bracket 14. The adjustable bracket 62 has a near end 64 and a distal end 66. The bicycle bracket 14 has a near end 126 and a distal end 128 and also has a fastener 130 that secures the bicycle bracket 14 to the bicycle seat post 18. The adjustable bracket 62 and the bicycle bracket 14 are attached by at least two fasteners 134 at attachment points 132. Also shown is the distal end 23 of tension spring 20 and attachment point 24. Also shown are the openings 76 through adjustable bracket 62.

FIG. 8 is a full side view of support arm 10 attached to the adjustable bicycle bracket 62. The near end 21 of the tension spring 20 is attached to the distal end 32 of mounting arm 28. The tension spring 20 is positioned to retain the drive wheel 58 so that it remains in constant contact with the bicycle tire 38. The near end 21 of tension spring 20 is attached to the near end 21 tension spring 20 attachment point 22. The distal end 23 of tension spring 20 is attached to the distal end attachment point 24. The distal end attachment point 24 is located essentially at the near end 64 of the adjustable bracket 62. The support arm 10 is attached to the adjustable bracket 62 at the distal end 70 of support arm 10 via the pivot point 12. The adjustability of the adjustable bracket 62 is possible via the openings 76. Also shown is the distal end 66 of the adjustable bracket 62.

The drive wheel 58 is partially visible behind the near end 68 of support arm 10. The drive wheel 58 rides on the drive shaft 56. The mounting arm 28 provides stability to the support arm 10 and its distal end 70 is configured for the attachment of near end attachment point 22. The near end 30 of mounting arm 28 supports a reflector 26.

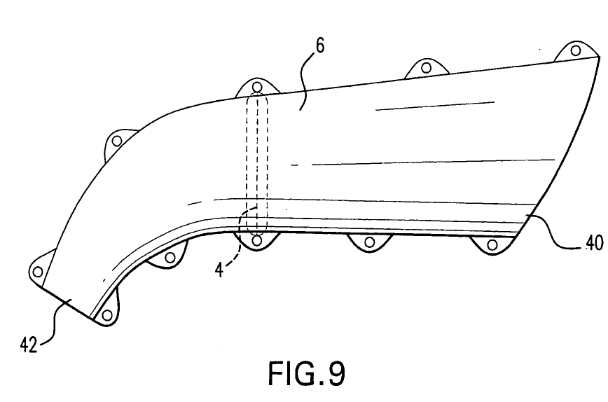

FIG. 9 is the hollow casing 6 that holds the tympanic membrane 4, shown in phantom. The hollow casing has a near end 40 and a distal end 42.

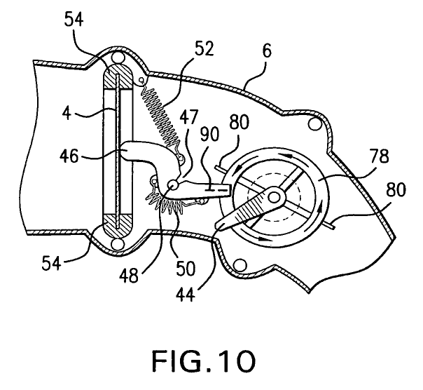

FIG. 10 is another embodiment of this invention showing a secondary actuator 80 on the free spinning flywheel 78 that allows the continuous generation of sound when the motion of the bicycle has ceased. These activators 80 of the free spinning flywheel 78 are mounted on the exterior of the free spinning flywheel 78 and they act upon a secondary hammer tab 90 (shown in phantom). The free wheel 78 spins while the actuator 80 remains immobile. The activation of the tab 81 drives the hammer 46 mounted to pivot point 48 acting upon the tympanic membrane 4. Also present is the notch 47 in the hammer 46. The purpose of the notch 47 is to allow actuator 44 to move in reverse with out damaging the tympanic membrane 4. Repositioning spring 50 brings the hammer 46 back into position after it has moved in the reverse direction. The repositioning spring 52 is present to reposition the hammer 46 after it has been driven in the forward movement by the actuator 44. As shown Supra, the tympanic membrane 4 is encased within the tympanic membrane collar 54 within the hollow casing 6.

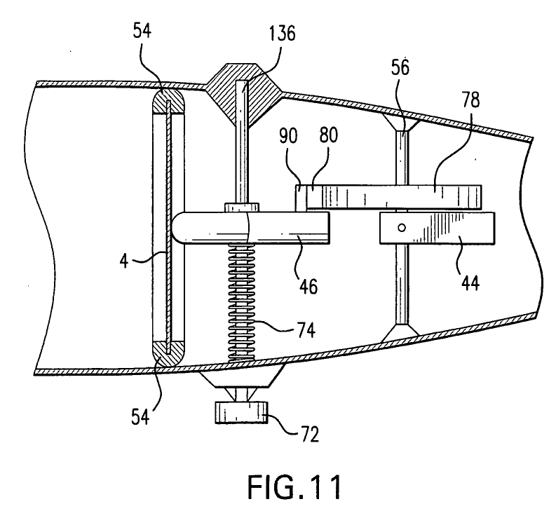

FIG. 11 is a full top view of the free spinning flywheel 78 emphasizing the secondary hammer tab 90. This view also emphasizes the disengagement mechanism 72. The disengagement mechanism 72 consists of shaft that has a spring 74. In this embodiment the hammer 46 is mounted to the disengagement shaft 136. The disengagement mechanism is pulled outward then turned, removing the hammer 46 and its tab 90 from the path of the actuator 44, and the free spinning flywheel 78 and its actuator 80, while it is still attached to the drive shaft 56. This allows the user to disengage the device to end the production of sound. Also shown is the tympanic membrane 4 within the tympanic membrane collar 54.

FIG. 12 is a full side view of the muffler sound simulator 2 mounted to a standard non-motor vehicle or in this embodiment a bicycle 92. It is clear from this view how the muffler sound simulator 2 mounts to the bicycle 92. The bike seat post 18 has the bike bracket 14 mounted to it. Also surmounting the bike seat post 18 is the bike seat 14 showing the relationship between the bracket 14 and the seat 18. The bike bracket 14 attaches to the support arm 10 at the pivot point 12. The tension spring 20 is mounted to the support arm 10. The flexible hose 8 is also attached to the support arm 10 at the distal end 36. The near end 68 of the support arm 10 contains the mounting arm 28. Surmounted on support arm 28 is the reflector 26. Not visible is drive wheel 58 that is located behind the hollow casing 6. The drive wheel 58 engages the bicycle tire 38 driving the device producing the muffler sound.

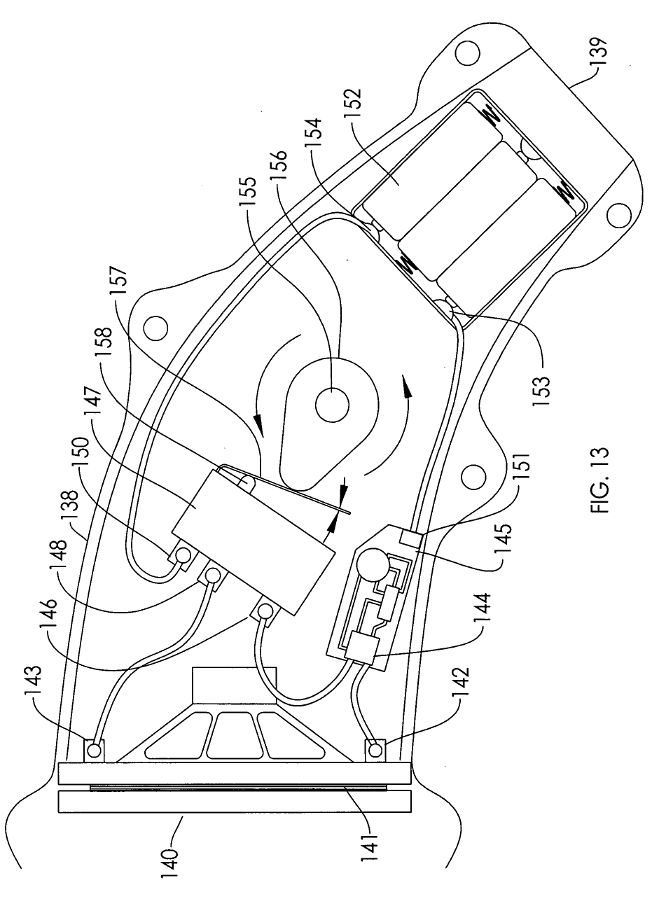

Turning now to FIG. 13, and the second embodiment of this invention, there is shown a device 175 with a full side view of a housing 138 that has a distal end 139 and a near end 140. Mounted in the distal end 139 is a speaker 141. The speaker 141 as shown has two electrical tab 142 and 143. All interconnections referred to in this specification are made with conductive electrical wiring.

The electrical tab 142 is electrically connected to a printed circuit board 145 at electrical tab 144 on the circuit board 145. For purposes of this invention, the circuit board 145 is programmed with the sounds of a muffler, much in the same manner as the sound produced by the first embodiment of this invention set forth Supra.

It should be noted that the electrical tab 144 on the circuit board 145 is also electrically connected to one of three electrical tabs 146 on a momentary contact switch 147. At the opposite end 149 of the printed circuit board 145 is yet another electrical tab 151 that is electrically connected to a battery array 152 at electrical connection 153.

The battery array 152 is further electrically connected at tab 154 to the momentary contact switch 147 at electrical tab 150. The electrical tab 148 on the momentary contact switch 147 is electrically connected to the electrical tab 143 on the speaker 141. This connection completes the potential circuit for the device.

In the center of the housing 138 is mounted an axle 155, and there is mounted on the axle 155, a rotational actuator 156 that has a cam configuration. As with the actuator 98 of the first embodiment of this invention, the rotational actuator 156 rotates with the axle 155 which in turn is rotated by the drive wheel 58 noted Supra, that contacts the bicycle wheel for driving power (see FIGS. 2 and 5 and 5A).

The rotational actuator 156, upon rotation, strikes a switch tab 157. When struck, the switch tab 157 compresses a switch button 158, located in the momentary contact switch 147 which in turn completes the circuit and allows for the output from the printed circuit board 145 to go to the speaker 141.

Thus, as a person rides the bicycle, the drive wheel 58 contacts the bicycle wheel which rotates the rotational actuator 156, that compresses the switch tab 157, that compresses the switch button 158 that completes the circuit and allows the speaker to broadcast muffler sounds.

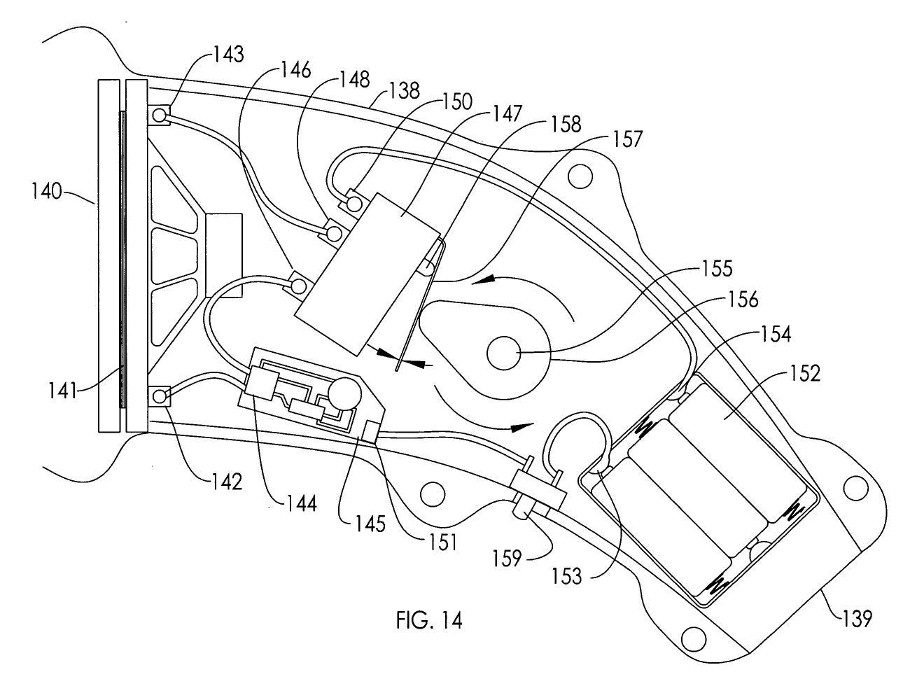

On the other hand, if the rider does not desire to hear the muffler sound, the drive wheel can be raised and held away from the bicycle wheel and the sound ceases. Also contemplated within the scope of this invention is a device 175 that has an electrical control switch that will start or stop the muffler sound on demand. Such a control switch can be found in FIG. 14, which is essentially FIG. 13 showing such a control switch at 159 which interrupts the electricity flow to the momentary contact switch 147. It is contemplated within the scope of this invention to place a control switch 159 in any convenient place in the electrical scheme as shown in FIGS. 13 and 14, and this invention is not limited to that shown in FIG. 14.

What is claimed is:

1. A muffler sound simulator device, said device comprising a hollow housing and contained in said hollow housing, a muffler sound simulator comprising in combination:
a tympanic membrane affixed in the hollow housing;
a hammer in striking alignment with said tympanic membrane, said hammer mounted on a first axle wherein the first axle is mounted in the sides of the hollow housing and supported by the hollow housing, said hammer having a front, a back and a bottom and said hammer and axle being located such that the hammer is capable of periodically touching the tympanic membrane;
said hammer having a spring attachment located on each of the back and the front thereof, said hammer having a notch in the back thereof, said notch extending through the back and up to the first axle;
an actuator, said actuator being mounted on a second axle, said second axle being mounted in the hollow housing and supported thereby, said second axle being extended on one end outside of the hollow housing;
there being mounted on the second axle extended end, a rotatable drive wheel;
a support frame, said support frame having a near end and a distal end, and a centrally located cross member; said support frame mountable to the frame of a bicycle at the distal end thereof and the terminal end of the second axle being supported by the support frame at the near end;
one end of a tension spring being attached to the cross member and the opposite end of the spring being attached to the distal end of the support frame;
one end of a second spring being attached to the spring attachment on the back of the hammer and the opposite end being attached to the hollow housing;
one end of a third spring being attached to the spring attachment on the bottom of the hammer, the opposite end being attached to the chamber.

2. A muffler sound simulator as claimed in claim 1 wherein in addition, the distal end of the support frame is mounted to an adjustable attachment bracket.

3. A muffler sound simulator as claimed in claim 2 wherein in addition, the adjustable attachment bracket has a near end and a distal end and the distal end is adapted to be mountable on the frame of a bicycle.

4. A muffler sound simulator as claimed in claim 3 wherein in addition, the adjustable attachment bracket has a spring attachment mounted on the distal end.

5. A muffler sound simulator as claimed in claim 4 wherein in addition, there is rotatably mounted near the near end of the support frame, a drive wheel.

6. A muffler sound simulator as claimed in claim 5, wherein in addition, there is a tension spring attached by one end to the spring attachment on the adjustable attachment bracket and the opposite end is attached to one end of the support arm.

7. A muffler sound simulator as claimed in claim 1 wherein in addition, there is a weighted fly wheel mounted adjacent the actuator and on the second axle.

8. A muffler sound simulator as claimed in claim 1 wherein in addition, there is a means for preventing the hammer from being struck with the actuator.

9. The means as claimed in claim 8 comprising:
a shaft, a spring surrounding said shaft, said shaft having a near end and a distal end; a knob mounted on said distal end of said shaft, said shaft penetrating said outer casing, a turning device, a locking device, a disengaging device.

10. A muffler sound simulator device, said device comprising a hollow housing and contained in said hollow housing, a muffler sound simulator comprising in combination:
a speaker,
a printed circuit board with a predetermined circuit formed thereon;
a battery array;
a rotational actuator, and,
a momentary contact switch having at least three electrical connective tabs,
the printed circuit being electrically attached to the speaker, the battery array, and at one of the three electrical connective tabs of the momentary contact switch;
the battery array being electrically attached to one of the three electrical connective tabs that is not the same connection as the connection for the printed circuit;
the speaker being electrically connected to one of the three electrical connective tabs that is not connected to either the printed circuit board or the battery array;
the rotational actuator being a cam that is mounted on an axle that is mounted in the housing, said rotational actuator being in periodic contact with a switch tab that is attached to the momentary contact switch, said switch tab being in constant contact with an actuator button mounted on the momentary contact switch such that when the cam rotates and presses the switch tab, the switch tab presses the actuator button and completes the circuit.
